(19) United States
(12) Patent Application Publication
(10) Pub. No.: US 2012/0007716 A1
(43) Pub. Date: Jan. 12, 2012

(54) RFID TAG TRACKING SYSTEM AND RFID TAG TRACKING METHOD

(75) Inventors: Jiunn-Jye Lee, Taipei County (TW); Jui-Yu Li, Taoyuan County (TW)

(73) Assignee: GETAC TECHNOLOGY CORPORATION, Hsinchu (TW)

(21) Appl. No.: 12/831,080

(22) Filed: Jul. 6, 2010

(51) Int. Cl. H04Q 5/22

(52) U.S. Cl. 340/10.4

(57) ABSTRACT

A radio frequency identification (RFID) tag tracking system is provided for performing an RFID tag tracking method. The RFID tag tracking system includes an RFID tag, at least one RFID reader, and a backend-server. The RFID tag periodically emits tag signals having different original signal strengths, and the original signal strength of each tag signal determines a signal receiving boundary relative to the RFID tag. The RFID reader is used to receive the tag signals, and the tag signal that can be received by the RFID reader receives the tag signals, and determines one or more receivable signals which cab be received by the RFID reader among the tag signals. The backend-server determines a possible position area of the RFID tag relative to the RFID reader according to the signal receiving boundary of the receivable signal.

### BACKGROUND OF THE INVENTION

1. Field of the Invention

The present invention relates to a tracking technology, and more particularly to a radio frequency identification (RFID) tracking system and a RFID tracking system.

2. Related Art

The radio frequency identification (RFID) system is a wireless communication technology that has been widely researched and developed in recent years. Basically, an RFID system is a wireless communication network including an RFID reader and an RFID tag.

The RFID tag tracking is one of the applications of the RFID system. As shown in FIG. 1, in an RFID tracking system in the prior art, an RFID tag 10 emits a wireless tag signal, and an RFID reader 20 receives the tag signal and determines the distance between the RFID tag 10 and the RFID reader 20 according to the decay degree of signal strength of tag signals.

As shown in FIG. 1, signal strength of the tag signal emitted by the RFID tag 10 is −40 dBm. When the strength of the tag signal received by the RFID reader 20 is −60 dBm, decay degree of signal strength of the tag signal is 20 dB. The decaying degree of signal strength of 20 dB is introduced into a strength decay equation, and a distance of about 30 cm is derived. When the strength of the tag signal received by the RFID reader 20 is −70 dBm, the decay degree of signal strength of the tag signal is 30 dB. The decay degree of signal strength of 30 dB is introduced into a strength decay equation, and a distance of about 40 cm is derived. Based on the sensitivity of the RFID reader 20, the signal strength that can be read by the RFID reader 20 has a lower limit. If the signal strength decays to a small values, e.g. if the decay degree of signal strength is 50 dB such that the signal strength reaching the RFID reader 20 is −90 dBm, the signal strength may be far below the sensitivity of the RFID reader 20, and the RFID reader 20 cannot generate a reading value of the signal strength in fact. At this time, the distance between the RFID tag 10 and the RFID reader 20 is greater than the maximum receiving boundary of the RFID reader 20.

As shown in FIG. 2, when a plurality of RFID readers 20, 30, 40 is adopted to receive tag signals at the same time, the distances between the RFID tag 10 and the RFID readers 20, 30, 40 can be determined. The schematic view of FIG. 2 shows spheres with the RFID readers 20, 30, 40 as centers and the above distances as radii. Ideally, the spheres intersect at a point, and this point is the position of the RFID tag 10. However, limited by the accuracy of signal strength readings of the RFID readers 20, 30, 40, the spheres form an intersection region 50, and the RFID tag 10 is located with the intersection region 50.

The strength decay curve of the tag signals is shown in FIG. 3. When the distance exceeds a certain range, the strength decay curve presents an irregular nonlinear variation, and the stable region of the linear decay is approximately only in the certain range, such that the strength decay equation for calculating the distance is inapplicable. Further, different environments will influence the decay degree of signal strength, and barriers in an environment may reflect, refract, or absorb the tag signal according to the materials of the barriers, thus generating nonlinearly-varying decay degree of signal strength. The aforementioned equation can only be used to estimate a linear strength-distance relationship, and in a real environment, the strength-distance relationship varies nonlinearly. Therefore, the strength decay equation cannot be used to accurately measure the distances between the RFID tag 10 and the RFID readers 20, 30, 40.

### SUMMARY

In the RFID tracking system in the prior art, numerous uncertain factors that cause the nonlinear-varying decay degree of signal strength of tag signals exist between the RFID tag and the RFID reader, resulting in inaccurate tracking In view of the above problems, the present invention is directed to a tracking system and an RFID tag tracking method, in which the calculation of the decay degree of signal strength of tag signals is not required, thus eliminating the tracking errors caused by uncertain factors of signal strength decay of the tag signals.

The RFID tracking system of the present invention includes an RFID tag, at least one RFID reader, and a backend-server.

The RFID tag periodically emits a plurality of tag signals having different original signal strengths, and the original signal strength of each tag signal determines a signal receiving boundary relative to the RFID tag. The RFID tag can be an active-type RFID tag, which actively emits the tag signals by using a self-contained electrical power source. Alternatively, the RFID tag can be a passive-type RFID tag, and the RFID reader periodically emits a trigger signal to activate the RFID tag to emit the tag signals.

The RFID reader is for receiving the tag signals emitted by the RFID tag, and the RFID reader receives a tag signal having a receiving strength greater than a threshold value in the corresponding signal receiving boundary. When the strength of the tag signal received by the RFID reader is greater than the threshold value, the received tag signal is read as a receivable signal, and the RFID tag is located in the corresponding receiving boundary. The backend-server determines a possible position area of the RFID tag relative to the RFID reader according to the signal receiving boundary corresponding to the receivable signal.

A plurality of RFID readers can be included in the RFID tracking system, such that the RFID tag has a possible position area corresponding to each RFID reader respectively, and the backend-server determines an intersection region of the possible position areas as a speculated position of the RFID tag.

The present invention is further directed to an RFID tag tracking method, for identifying an RFID tag and determining a position of an RFID tag by an RFID reader.

In the method of the present invention, the RFID tag periodically emits a plurality of tag signals having different original signal strengths. The original signal strength of each tag signal determines a signal receiving boundary relative to the RFID tag.

The RFID reader receives a corresponding tag signal having a receiving strength greater than a threshold value in each signal receiving boundary. Therefore, after receiving the tag signals, the RFID reader finds out the tag signals having a receiving strength greater than the threshold value, and determines the tag signals having a receiving strength greater than the threshold value as receivable signals. Finally, the backend-server determines a possible position area of the RFID tag according to the signal receiving boundaries corresponding to the receivable signals.

In the method of the present invention, one or more other RFID readers may be further used to obtain other possible position areas of the RFID tag, and determine an intersection region of the possible position areas as a speculated position of the RFID tag.

Through the above combination, in the present invention, by simply determining whether the RFID reader has received the tag signals and finding out the signal receiving boundaries determined by the original signal strengths of the tag signals, the backend-server can determine a possible position area of the RFID tag relative to the RFID reader according to the overlapping relation of the signal receiving boundaries. Since the backend-server or the RFID reader is not required to determine the decay degree of signal strength of tag signals and perform complex equation calculations according to the decay degree of signal strength of tag signals of the tag signals, the hardware resources required by the overall RFID tracking system are reduced, such that the RFID tracking system is more stable and has a higher tracking speed. Meanwhile, the backend-server or the RFID reader determines the possible position area of the RFID tag without using the decay degree of signal strength of tag signals, such that the tracking errors caused by uncertain factors of attenuation of the tag signals are avoided, thereby providing a more accurate tracking result.

### BRIEF DESCRIPTION OF THE DRAWINGS

The present invention will become more fully understood from the detailed description given herein below for illustration only, and thus are not limitative of the present invention, and wherein:

FIG. 1 is a schematic diagram of an RFID tracking system in the prior art;

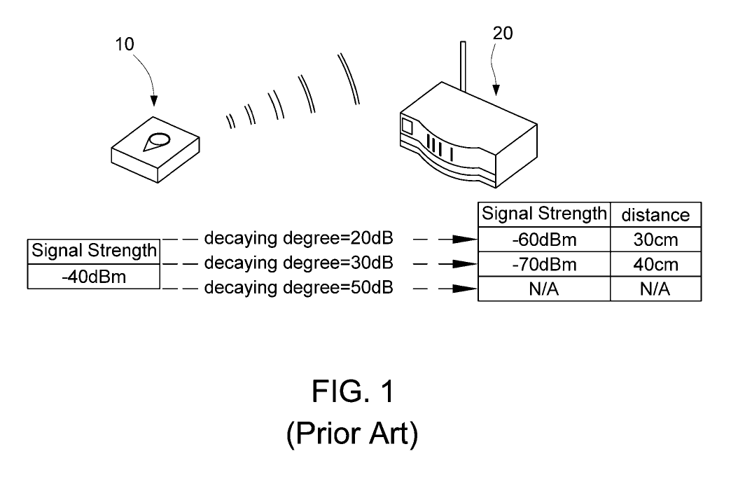

FIG. 2 is a schematic diagram of an RFID tracking system in the prior art when tracking an RFID tag;

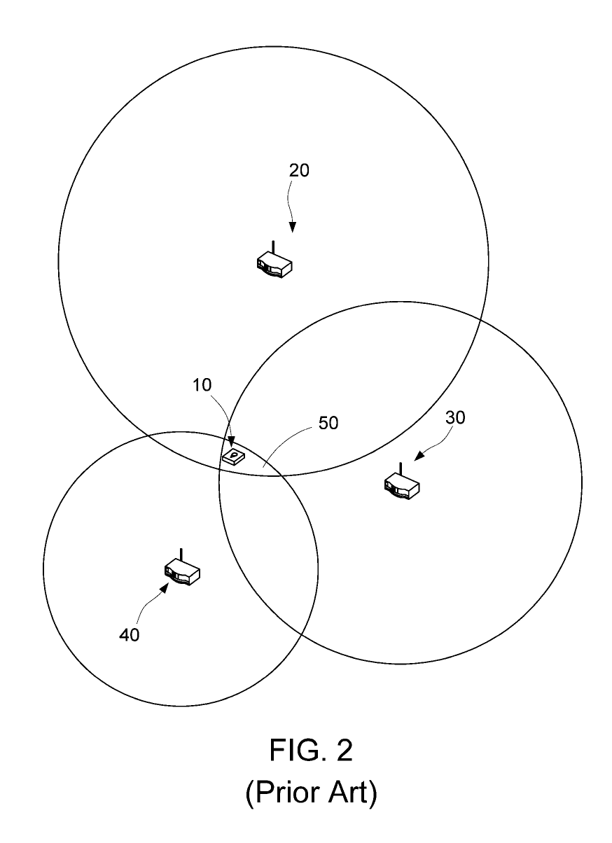

FIG. 3 is a schematic diagram of a strength-distance relationship of an RF signal;

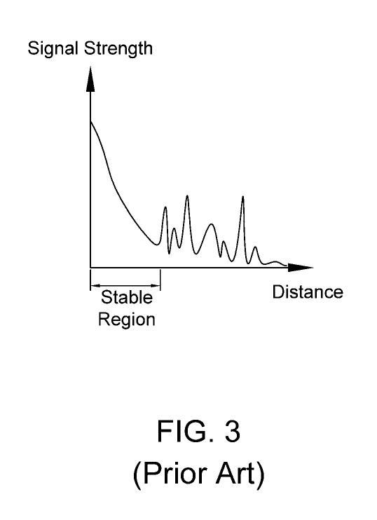

FIG. 4 is a schematic diagram of an RFID tag tracking system according to a preferred embodiment of the present invention;

FIG. 5 is a schematic diagram of tag signals of an RFID tag tracking system according to the preferred embodiment of the present invention;

FIG. 6 is a schematic diagram of deriving a position by an RFID tag tracking system according to the preferred embodiment of the present invention;

FIG. 7 is a flowchart of an RFID tag tracking method according to a first embodiment of the present invention; and

FIG. 8 is a flowchart of an RFID tag tracking method according to a second embodiment of the present invention.

### DETAILED DESCRIPTION

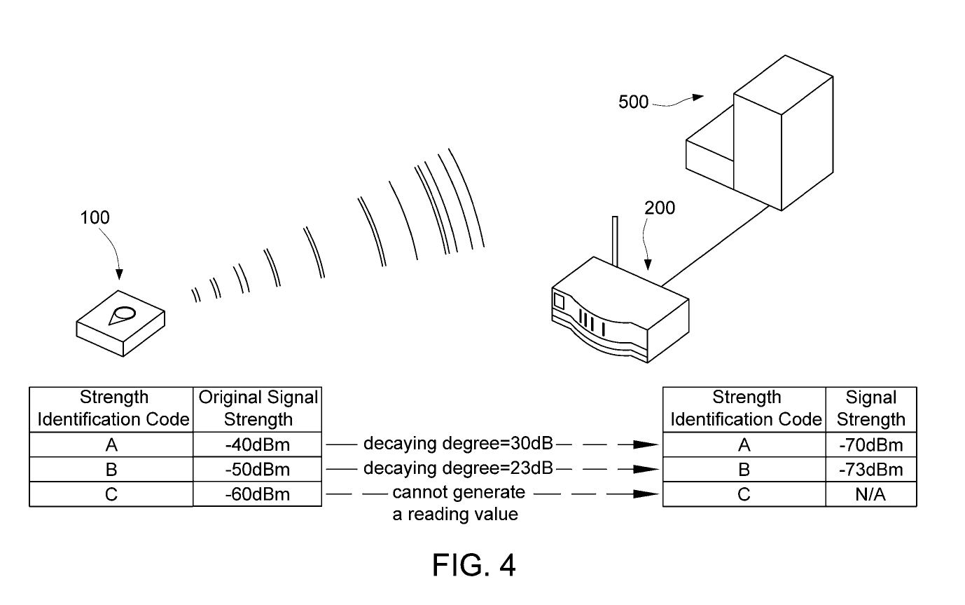

FIG. 4 shows a schematic diagram of a radio frequency identification (RFID) tag tracking system according to a preferred embodiment of the present invention. The RFID tag tracking system includes an RFID tag 100, an RFID reader 200 and a backend-server 500.

Referring to FIG. 4, the RFID tag 100 periodically emits a plurality of tag signals having different original signal strengths. Each tag signal carries a strength identification code A, B, C, and each strength identification code A, B, C contains the original signal strength (−40 dBm, −50 dBm, −60 dBm) of each tag signal when the tag signal is emitted by the RFID tag 100, such that the RFID reader 200 or the backend-server 500 can differentiate each of the tag signals, and determine the original signal strength of each tag signal. The signal strength of each tag signal decays with the transmission distance, and the tag signals are received by the RFID reader 200.

As illustrated by FIG. 4, the RFID tag 100 periodically emits three tag signals having different original signal strengths, and the original signal strengths corresponding to the strength identification codes A, B, C are respectively −40 dBm, −50 dBm, and −60 dBm. After transmitted to the RFID reader 200, the decay degree of signal strength of each tag signal is different. In this embodiment, the signal strengths of the tag signals of the strength identification code A and the strength identification code B decay to −70 dBm and −73 dBm when received by the RFID reader 200. Since the tag signals can still be received by the RFID reader 200, and the RFID reader determines the tag signals containing the strength identification code A and the strength identification code B as receivable signals. The signal strength of the tag signal carrying the strength identification code C decays to a small value, and the tag signal carrying the strength identification code C cannot be received by the RFID reader 200. Therefore, the RFID reader 200 does not determine the tag signal containing the strength identification code C as a receivable signal.

In addition, the RFID tag 100 may be an active-type RFID tag or a passive-type RFID tag. The active-type RFID tag actively emits the tag signals by using a self-contained electrical power source. The passive-type RFID tag requires an RFID reader 200 to periodically emit a trigger signal to activate the RFID tag 100 to emit the tag signals.

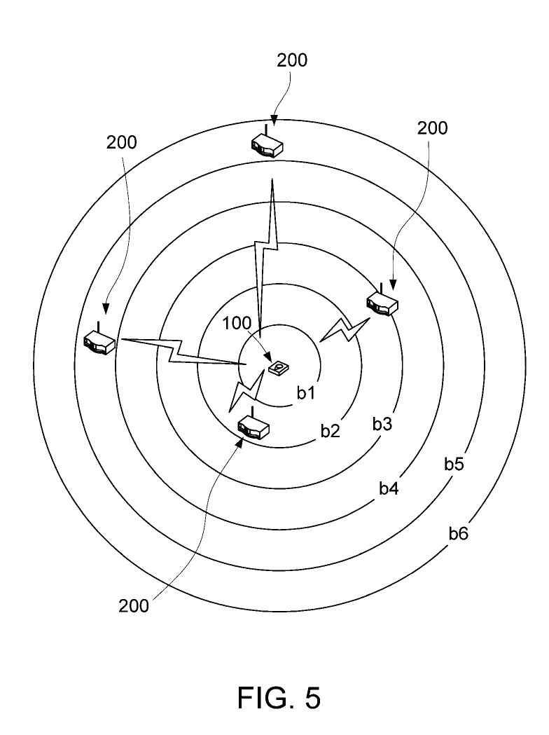

Referring to FIG. 5, the RFID reader 200 is used to receive the tag signals emitted by the RFID tag 100. The original signal strength of each tag signal emitted by the RFID tag 100 determines a signal receiving boundary relative to the RFID tag 100. In the signal receiving boundary, the RFID reader 200 can receive a corresponding tag signal and determines the tag signal as a receivable signal. As shown in FIG. 5, the RFID tag 100 sequentially emits six tag signals having different original signal strengths. Since the original signal strengths of the tag signals are different, the signal receiving boundaries of the tag signals relative to the RFID tag 100 are different, and thus the distances of the tag signals that can be received by the RFID reader 200 and determined as the receivable signals are different. Therefore, according to the original signal strengths of the tag signals, six signal receiving boundaries b1 to b6 corresponding to different tag signals respectively are defined. The RFID reader 200 must be located within the signal receiving boundaries b1˜b6, so as to receive corresponding tag signals and determine the tag signals as the receivable signals. That is, when a tag signal is a receivable signal, the RFID reader 200 is located within the corresponding receiving boundary b1, b2 . . . or b6.

Referring to FIG. 5, the larger the original signal strength of the tag signal is, the wider the corresponding one of the signal receiving boundaries b1˜b6 will be. For example, if a tag signal has the largest original signal strength among the six tag signals and the corresponding receiving boundary is b6 which has a maximum range among the signal receiving boundaries b1˜b6, and the RFID reader 200 can receive the tag signal in the range of b6 (including the ranges of b1˜b5). On the contrary, if a tag signal has the smallest original signal strength among the six tag signals and the corresponding receiving boundary is possibly b1 which has a minimum range among the signal receiving boundaries b1˜b6, and the RFID reader 200 can only receive the tag signal in the range of b1, and cannot receive the tag signal having the smallest original signal strength in the area between b6 and b1 or outside b6.

Referring to FIGS. 4 and 5, the backend-server 500 is used to find the receivable signals received by the RFID reader 200, and determine a possible position area of the RFID tag 100 relative to the RFID reader 200 according to the signal receiving boundaries b1˜b6 corresponding to the receivable signals.

Referring to FIG. 4, after the RFID tag 100 emits tag signals for a period, the RFID reader 200 receives the tag signals. To avoid the false determination caused by noise interference, the RFID tag 100 continuously emits tag signals to increase the sample number of the tag signals to the backend-server 500, or the variation of the possible position area of the RFID tag 100 is continuously determined.

The criteria for determining whether the RFID reader 200 receives the tag signal is whether the receiving strength of the corresponding tag signal received by the RFID reader 200 is greater than a threshold value. When the receiving strength of the corresponding tag signal received by the RFID reader 200 is greater than the threshold value, the received tag signal is determined as a receivable signal. The threshold value may be set to be 0, that is, when the RFID reader 200 receives a tag signal, the tag signal is determined as the receivable signal, and it is determined that the RFID reader 200 is located within the signal receiving boundary b1, b2, . . . , or b6 corresponding to the tag signal. In practice, the threshold value has a value of greater than 0, so as to eliminate system or external noises.

The RFID reader 200 is connected to the backend-server 500 in a wired or wireless manner. The receivable signal received by the RFID reader 200 is transmitted to the backend-server 500. The backend-server 500 determines a possible position area of the RFID tag 100 relative to the RFID reader 200 according to the signal receiving boundaries b1˜b6 of the receivable signals.

Since the original signal strength of the tag signal emitted by the RFID tag 100 cannot be derived from the receiving strength of the tag signal received by the RFID reader 200, the tag signals need to carry the strength identification codes, and the strength identification code contains the original signal strength of each tag signal when emitted by the RFID tag 100. Thus, the RFID reader 200 or the backend-server 500 can differentiate the tag signals which are determined as the receivable signals according to the strength identification codes, and obtain the original signal strengths. When a tag signal is a receivable signal, the backend-server 500 may find out the corresponding receiving boundary b1˜b6 according to the original signal strength corresponding to the strength identification code, and determine that the RFID reader 200 is located within the signal receiving boundary b1˜b6 corresponding to the receivable signal.

In addition to the strength identification codes, since the signal receiving boundaries b1˜b6 may be determined and stored in the backend-server 500 in advance, the strength identification codes may also be replaced by receiving boundary identification codes. That is, each tag signal carries a signal receiving boundary identification code. The signal receiving boundary identification codes are respectively corresponding to different signal receiving boundaries b1˜b6 according to the tag signals having different original signal strengths. Each of the signal receiving boundaries b1˜b6 represents the range of the tag signals having different original signal strengths which are determined by the RFID reader 200 as the receivable signals after emitted by the RFID tag 100. Therefore, the signal receiving boundary identification codes of the receivable signals may be used for the backend-server 500 to determine which one of the signal receiving boundaries b1˜b6 the RFID reader 200 is located in.

It should be noted that, although the signal receiving boundaries b1˜b6 as shown in FIG. 5 present circles in two-dimension, in practice, the tag signals are emitted in all directions in space, so that the signal receiving boundary of each tag signal is theoretically a sphere with the RFID tag 100 as the center. However, in practice, the transmission of the tag signals may be blocked, reflected, refracted or otherwise interfered by the environmental landscape, or the emitting antenna of the RFID tag 100 has slightly directional emitting characteristic, which causes enhancement or attenuation of the tag signal in a certain direction, so that the real signal receiving boundaries b1˜b6 are mostly closed blocks formed by irregular curves. Therefore, in practice, the signal receiving boundaries b1˜b6 are preferably defined by the in-site sampling result of the preset environment of the RFID tag 100 and the RFID reader 200. The signal receiving boundaries b1˜b6 sampled in site are not obtained through complex equation calculations according to the decaying rate of the tag signals. Therefore, the hardware resources required by the overall tracking system are reduced, and the tracking errors caused by uncertain factors of attenuation of the tag signals are avoided.

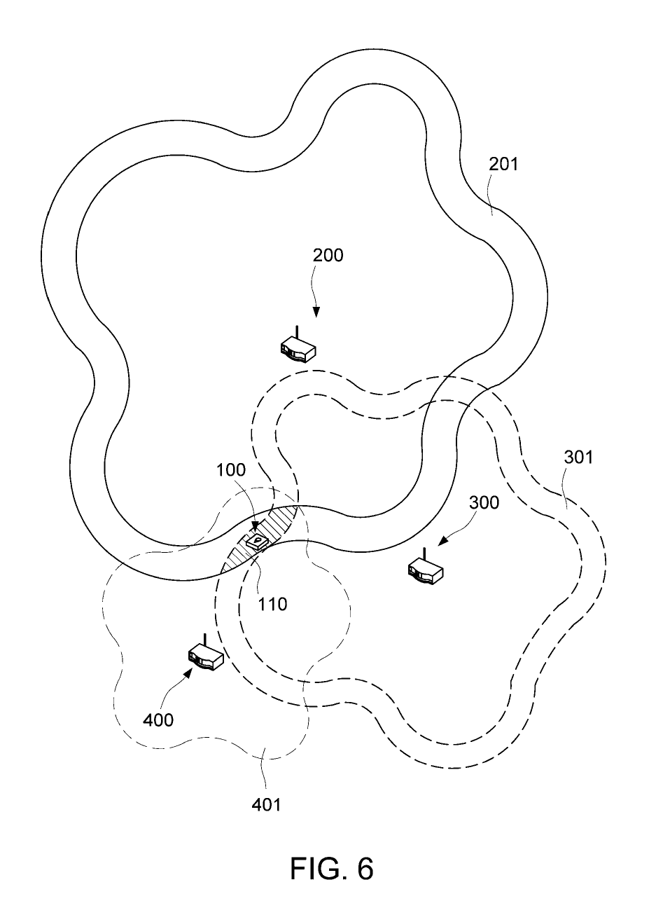

Referring to FIG. 6, according to the signal receiving boundaries of the receivable signals, the backend-server 500 may derive the possible position areas 201, 301, 401 of the RFID tag 100 relative to the RFID readers 200, 300, 400.

As shown in FIG. 6, the RFID tag tracking system has a plurality of RFID readers 200, 300, 400, and the RFID tag 100 periodically emits tag signals. Each RFID reader 200 firstly determines whether the tag signals are receivable signals, and transmits the receivable signals to the backend-server (not shown in FIG. 6). Then, the backend-server derives the possible position areas 201 301, 401 of the RFID tag 100 relative to the RFID readers 200, 300, 400 according to the signal receiving boundaries of the receivable signals. Finally, the backend-server 500 determines an intersection region of the possible position areas 201, 301, 401 as a speculated position 110 of the RFID tag 100.

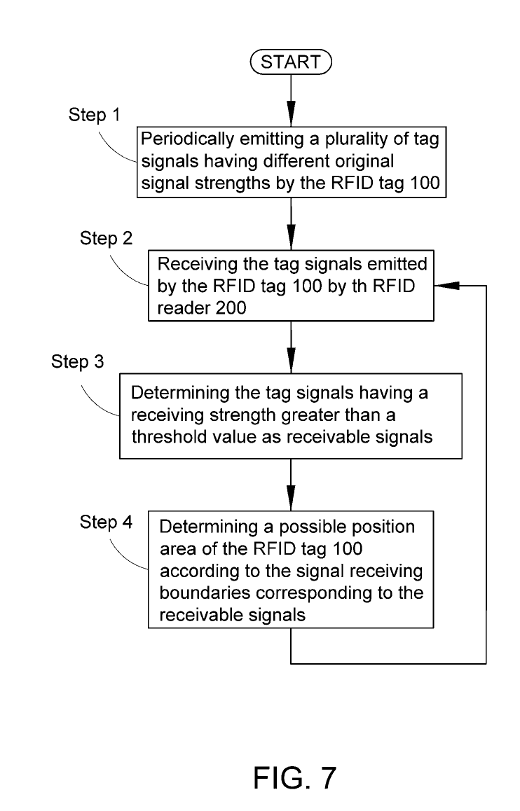

FIG. 7 is a flowchart of the RFID tag tracking method according to a first embodiment of the present invention. The RFID tag tracking method is applied in the tracking system of the present invention. The steps of the RFID tag tracking method are illustrated as follows.

Step 1:

The tracking system periodically emits a plurality of tag signals having different original signal strengths by the RFID tag 100.

Each of the tag signals respectively carries a strength identification code, and each strength identification code contains the original signal strength of each tag signal when the tag signal is emitted by the RFID tag 100, and the strength identification code is used for determining the original signal strengths of the tag signals. The original strengths of the tag signals determine signal receiving boundaries b1˜b6 relative to the RFID tag, so that the strength identification code is used to determine the signal receiving boundaries b1˜b6 corresponding to the tag signals. The strength identification code may also be a signal receiving boundary identification code, and the signal receiving boundary identification codes are respectively corresponding to different signal receiving boundaries b1˜b6 according to the tag signals having different original signal strengths. Therefore, the signal receiving boundary identification codes are used for determining the signal receiving boundaries b1˜b6 corresponding to the tag signals. The RFID tag 100 may be an active-type RFID tag, which actively emits the tag signals by using a self-contained electrical power source.

Since the original signal strengths of the tag signals determine the signal receiving boundaries b1˜b6 relative to the RFID tag 100, the RFID reader 200 must be located within the signal receiving boundaries b1˜b6, such that the receiving strength of the corresponding tag signal received by the RFID reader 200 is greater than a threshold value, thus determining the tag signal as a receivable signal. At this time, the position of the RFID reader 200 relative to the RFID tag 100 is located within the signal receiving boundaries b1˜b6 corresponding to the receivable signals.

Step 2:

The RFID tracking system receives the tag signals emitted by the RFID tag 100 by the RFID reader 200.

Step 3:

After receiving the tag signals, the RFID reader 200 determines the tag signals having a receiving strength greater than a threshold value as receivable signals. At this time, the RFID reader is in the signal receiving boundaries corresponding to the receivable signals.

For example, if the threshold value is −80 dBm (or may be 0), when the receiving strength received by the RFID reader 200 has a signal strength greater than −80 dBm, the RFID reader 200 determines the tag signals as receivable signals, and at this time, the RFID reader 200 is located within the signal receiving boundaries corresponding to the receivable signals. When the receiving strength received by the RFID reader 200 is smaller than −80 dBm or is 0 (no tag signal is received), the RFID reader 200 determines that the tag signal is not receivable signal, and at this time, the RFID reader 200 is located outside the signal receiving boundary of the tag signal.

Step 4:

When the tag signals are receivable signals, the backend-server 500 determines the RFID reader 200 is located within the signal receiving boundaries corresponding to the receivable signals. Therefore, the backend-server 500 may determine a possible position area 201 of the RFID tag 100 relative to the RFID reader 200 according to the signal receiving boundaries 210, 220 corresponding to the receivable signals.

The tracking system may adopt other RFID readers 300, 400 to receive the RF signals at the same time or sequentially, and after finding out possible position areas 301, 401 of the RFID tag 100 relative to the other RFID readers 300, 400, the backend-server 500 determines an intersection region of the possible position areas 201, 301, 401 as a speculated position 110 of the RFID tag 100.

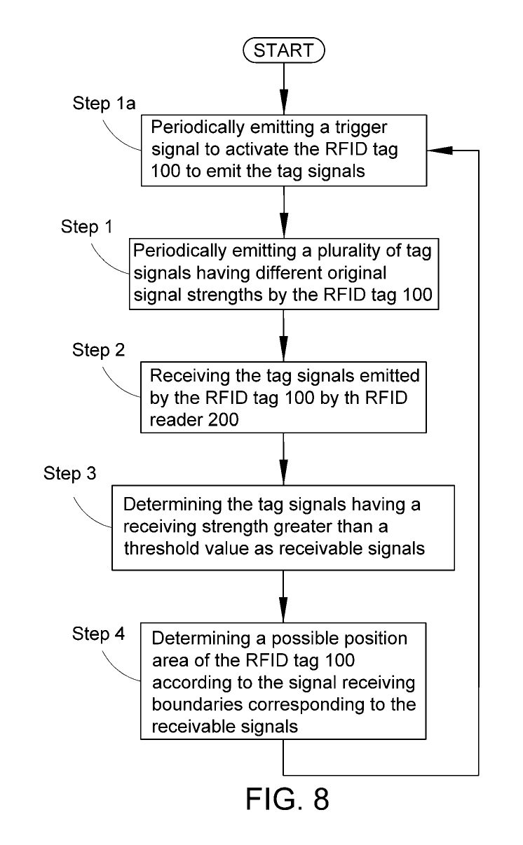

FIG. 8 is a flowchart of the RFID tag tracking method according to a second embodiment of the present invention. The RFID tag 100 of the second embodiment is a passive-type RFID tag, and the RFID tag tracking method of the second embodiment needs to be modified, in which the Step 1a is added before Step 1.

Step 1a:

The RFID reader 200 periodically emits a trigger signal to activate the RFID tag 100 to emit the tag signals.

Since the passive-type RFID tag 100 needs to be activated by the trigger signal so as to emit the tag signals, after Step 4 is completed, the flow returns to Step 1a to emit the trigger signal again, so as to enable the RFID tag 100 to continuously emit the tag signals.

While the present invention has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A radio frequency identification (RFID) tag tracking system, comprising:
an RFID tag, periodically emitting a plurality of tag signals having different original signal strengths, and the original signal strength of each tag signal determining a signal receiving boundary relative to the RFID tag;
at least one radio frequency identification (RFID) reader, for receiving the tag signals emitted by the RFID tag, and determining the received tag signal as a receivable signal when the RFID reader is in each signal receiving boundary and a receiving strength corresponding to the received tag signal is greater than a threshold value; and
a backend-server, for determining a possible position area of the RFID tag relative to the RFID reader according to the signal receiving boundary corresponding to the receivable signal.

2. The RFID tag tracking system as claimed in claim 1, wherein each tag signal carries a strength identification code, and the strength identification code contains the original signal strength of each tag signal when emitted by the RFID tag.

3. The RFID tag tracking system as claimed in claim 1, wherein each tag signal carries a signal receiving boundary identification code, the signal receiving boundary identification codes are respectively corresponding to different signal receiving boundaries according to the tag signals having different original signal strengths, and each signal receiving boundary represents a position range of the tag signals having different original signal strengths which are determined as the receivable signals by the RFID reader after emitted by the RFID tag.

4. The RFID tag tracking system as claimed in claim 1, wherein the RFID tag is an active-type RFID tag, which actively emits the tag signals by using a self-contained electrical power source.

5. The RFID tag tracking system as claimed in claim 1, wherein the RFID tag is a passive-type RFID tag, and the RFID reader periodically emits a trigger signal to activate the RFID tag to emit the tag signals.

6. The RFID tag tracking system as claimed in claim 1, wherein when the tag signal is a receivable signal, the backend-server determines that the RFID reader is located within the signal receiving boundary corresponding to the receivable signal.

7. The RFID tag tracking system as claimed in claim 1, wherein the tracking system has a plurality of RFID readers, the RFID tag has a possible position area relative to each RFID reader respectively, and the backend-server determines an intersection region of the possible position areas as a speculated position of the RFID tag.

8. A radio frequency identification (RFID) tag tracking method, for identifying an RFID tag and determining a position of the RFID reader, comprising the steps of:
periodically emitting a plurality of tag signals having different original signal strengths by the RFID tag, wherein the original signal strength of each tag signal determining a signal receiving boundary relative to the RFID tag;
receiving the tag signals by the RFID reader, wherein a receiving strength of a corresponding tag signal received by the RFID reader is greater than a threshold value when the RFID reader is in each signal receiving boundary;
determining the tag signals having a receiving strength greater than the threshold value as receivable signals by the RFID reader; and
determining a possible position area of the RFID tag according to the signal receiving boundaries corresponding to the receivable signals.

9. The RFID tag tracking method as claimed in claim 8, wherein each tag signal carries a strength identification code, and the strength identification code contains the original signal strength of each tag signal when emitted by the RFID tag.

10. The RFID tag tracking method as claimed in claim 8, wherein each tag signal carries a signal receiving boundary identification code, the signal receiving boundary identification codes are respectively corresponding to different signal receiving boundaries according to the tag signals having different original signal strengths, and each signal receiving boundary represents a position range of the tag signals having different original signal strengths which are determined as the receivable signals by the RFID reader after emitted by the RFID tag.

11. The RFID tag tracking method as claimed in claim 8, wherein the RFID tag is an active-type RFID tag, which actively emits the tag signals by using a self-contained electrical power source.

12. The RFID tag tracking method as claimed in claim 8, wherein the RFID tag is a passive-type RFID tag, and before the step of emitting the tag signals by the RFID tag, the method further comprises:
periodically emitting a trigger signal by the RFID reader to activate the RFID tag to emit the tag signals.

13. The RFID tag tracking method as claimed in claim 8, further comprising steps of: obtaining another possible position area of the RFID tag by at least another RFID reader, and determining an intersection region of the possible position areas as a speculated position of the RFID tag.
